(19) United States
(12) Patent Application Publication
(10) Pub. No.: US 2025/0177851 A1
(43) Pub. Date: Jun. 5, 2025

(54) CONTROLLER DEVICE, METHOD FOR CONTROLLING CONTROLLER DEVICE, AND PROGRAM

(71) Applicant: Sony Interactive Entertainment Inc., Tokyo (JP)

(72) Inventors: Yumi Ueda, Chiba (JP); Toshiyuki Ando, Tokyo (JP); Hitoshi Nakamura, Tokyo (JP)

(73) Assignee: Sony Interactive Entertainment Inc., Tokyo (JP)

(21) Appl. No.: 18/840,600

(22) PCT Filed: Mar. 9, 2022
(86) PCT No.: PCT/JP2022/010425

§ 371 Date: Aug. 22, 2024

(51) Int. Cl. A63F 13/211; A63F 13/214

(52) U.S. Cl. CPC A63F 13/211; A63F 13/214

(57) ABSTRACT

Provided is a controller device including a controller main body and a control unit, in which the control unit receives an operation performed by a user on the controller main body, estimates a posture of the controller main body, and generates information representing the contents of the received operation and outputs the information, by using the estimation result.

### TECHNICAL FIELD

The present invention relates to a controller device, a method for controlling the controller device, and a program.

### BACKGROUND ART

In VR (virtual reality) games and the like in which an HMD (head mounted display) is worn, in order to improve the sense of immersion, users are sometimes not allowed to see images of a real space. In such a case, users cannot see their hands and thus cannot check a direction of the game controller they are holding with their hands.

### SUMMARY

### Technical Problem

Due to such circumstances, under current conditions, users check a shape of a controller device (which is typically asymmetric) in a blind manner and, for example, adjust the direction of the controller device to hold the controller device as they expect, which is rather inconvenient.

The present invention has been made in light of the conditions described above, and has, as an object thereof, provision of a controller device, a method for controlling the controller device, and a program that are capable of increasing convenience.

### Solution to Problem

One mode of the present invention for solving the problem in the related art described above is a controller device including a controller main body and a control unit. The control unit includes operation receiving means that receives an operation performed by a user on the controller main body, estimating means that estimates a posture of the controller main body, and operation information generating means that generates and outputs information representing contents of the received operation.

### Advantageous Effect of Invention

According to the present invention, information representing the contents of the received operation is generated by estimating the posture and using the results of estimation, so that the information representing the contents of the operation can be generated irrespective of the manner of holding the controller device by the user, and the convenience can be improved.

### BRIEF DESCRIPTION OF DRAWINGS

FIG. 1 is a schematic block diagram illustrating a configuration example of a controller device according to an embodiment of the present invention and an information processing device connected thereto.

FIG. 2 is a configuration block diagram related to an example of the controller device according to the embodiment of the present invention.

FIG. 3 is a functional block diagram related to an example of the controller device according to the embodiment of the present invention.

FIG. 4 depicts explanation diagrams representing an example of detecting a hand and fingers of a user by the controller device according to the embodiment of the present invention.

FIG. 5 is a flowchart diagram illustrating an example of an operation of the controller device according to the embodiment of the present invention.

### DESCRIPTION OF EMBODIMENT

An embodiment of the present invention will be described with reference to drawings. Note that, in the following description and drawings, sizes and ratios among the width, length, and height of each unit, for example, are exemplary, and in reality, different sizes and ratios may be used.

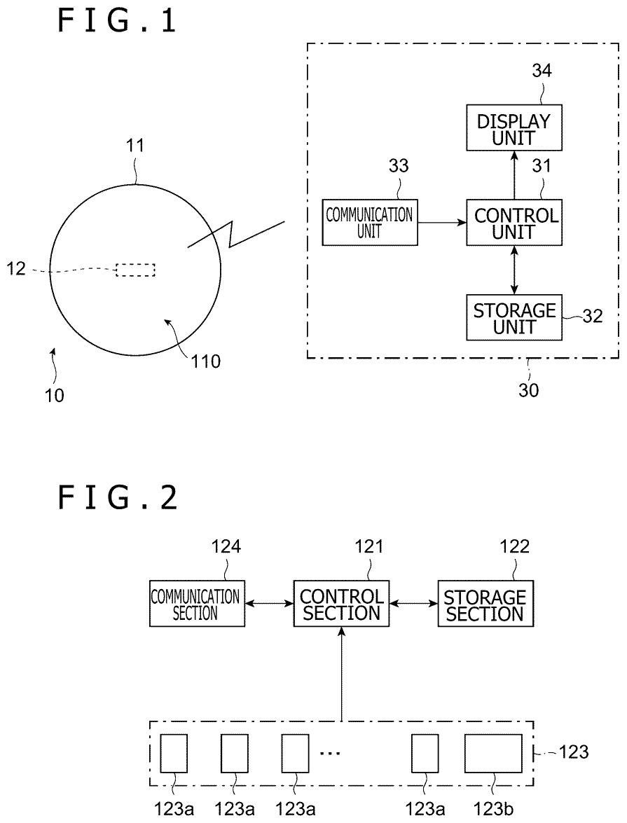

A controller device 10 according to the embodiment of the present invention includes, as illustrated in FIG. 1, a controller main body 11 and a circuit unit 12 built in the controller main body 11. The controller device 10 is connected to an information processing device 30 to allow communication therewith in a wired or wireless manner.

The information processing device 30 is, for example, a home video game console or the like, and includes a control unit 31, a storage unit 32, a communication unit 33, and a display unit 34. The control unit 31 is a program control device such as a CPU (central processing unit) and operates in accordance with the programs stored in the storage unit 32. In the example of the present embodiment, the control unit 31 uses information representing the contents of a user's operation that is received from the controller device 10 via the communication unit 33, and executes such processing of a game application or the like. Further, the control unit 31, in response to an instruction received from the controller device 10, performs such a process as displaying a guidance to a user.

The storage unit 32 includes a disk device, a memory device, and the like, and retains the programs to be executed by the control unit 31. Further, the storage unit 32 may operate as a work memory of the control unit 31.

The communication unit 33 is connected to the controller device 10 in a manner allowing communication therewith in a wired or wireless manner, to receive information representing the contents of the user's operation from the controller device 10 and output the information to the control unit 31.

The display unit 34 is, for example, a display controller or the like, and causes a display (not illustrated) to output and display images, in accordance with an instruction input from the control unit 31.

The controller main body 11 preferably has a rotationally symmetric shape around at least one axis and includes a housing 110 substantially forming a sphere, as one example. Yet, a sphere is an example, and the housing 110 may have a cylindrical shape or other shapes including a regular hexahedron which is not rotationally symmetric, for example. Further, a surface of the housing 110 may have irregularities by being subjected to blast treatment or the like.

In an example of the present embodiment, the housing 110 may be elastically deformable, and in that case, the housing 110 is configured with use of an elastically deformable material such as a polymer gel material including a silicone polymer gel material and an urethane gel material and various kinds of elastomer materials including polystyrene elastomer, olefin elastomer, polyvinyl chloride elastomer, polyurethane elastomer, polyester elastomer, and polyamide elastomer.

As illustrated in FIG. 2, the circuit unit 12 includes a control section 121, a storage section 122, a sensor section 123, and a communication section 124. These sections of the circuit unit 12 operate by an unillustrated battery. This battery may be a secondary battery chargeable by, for example, a wireless or wired feeding method.

Further, the circuit unit 12 is suitably disposed on a rotational axis of the controller main body 11 in a case where the controller main body 11 has a rotationally symmetric shape. For example, in a case where the controller main body 11 is in the shape of a sphere, the circuit unit 12 is preferably disposed such that the center of gravity thereof is positioned at a point corresponding to the center of the housing 110 of the controller main body 11 constituting a sphere. This arrangement is for smoothing the rotation about the rotational axis.

The control section 121 of the circuit unit 12 includes a program control device such as a CPU and operates in accordance with a program stored in the storage section 122. In the example of the present embodiment, the control section 121 receives an operation performed by the user on the controller main body 11. Further, the control section 121 executes the process of estimating the posture of the controller main body 11, using the result of estimation, generating information representing the contents of the received operation, and outputting the information to the information processing device 30. Detailed operation of the control section 121 will be described later.

The storage section 122 is, for example, a memory device and retains the programs to be executed by the control section 121. The storage section 122 also operates as a work memory of the control section 121.

The sensor section 123 includes a plurality of surface sensors 123a that are capable of detecting that the user has contacted or come close to the surface of the controller main body 11 or the force applied by the user on the surface of the controller main body 11, as exemplified by an electrostatic sensor, a pressure sensor, a strain sensor, a temperature sensor, and sensors of a combination of these.

Further, the sensor section 123 includes a posture sensor 123b that includes at least one of a position information sensor such as a GPS (global positioning system) sensor, an acceleration sensor, a geomagnetic sensor, and a gyro sensor that detect the posture and movement of the controller device 10. The posture sensor 123b may, for example, be what is generally called a 9-axis IMU (inertial measurement unit) sensor including all of the acceleration sensor, the geomagnetic sensor, and the gyro sensor. In the following example, the posture sensor 123b is assumed to be a 9-axis IMU sensor.

By using the position of the posture sensor 123b as the origin, the posture sensor 123b detects the acceleration in the three axis directions (hereinafter referred to as ξ-axis, η-axis, and ζ-axis) that are perpendicular to one another, a geomagnetic direction (the north pole or south pole direction) in a coordinate system defined by the three axes (a ξηζ Cartesian coordinate system; hereinafter referred to as the sensor coordinate system), and the rotational angular velocity about each of ξ-, η-, and ζ-axes, and outputs a signal representing the result of detection to the control section 121.

In one example of the present embodiment, the controller device 10 uses an analog MPX (multiplexer), sequentially selects and outputs an output of any of the acceleration sensor, the geomagnetic sensor, and the gyro sensor included in the posture sensor 123b, performs A/D (analog-to-digital) conversion, and applies predetermined signal processing such as filtering processing by a DSP (digital signal processor) or the like, to output the resultant output to the control section 121.

The surface sensor 123a detects user's contact with the controller main body 11 and an operation of deforming the controller main body 11 by the user and outputs an electric signal based on the detected contact or deformation operation to the control section 121. This output of the surface sensor 123a may also be subjected to A/D conversion and predetermined signal processing such as filtering processing by a DSP or the like and output to the control section 121. Note that, for example, including an oscillation circuit that oscillates signals to the supplied to an electrostatic sensor is widely known, so that detailed explanation is omitted here.

In one example of the present embodiment, a plurality of surface sensors 123a are provided on the surface of the controller main body 11 or near the surface (in a range within a predetermined distance from the surface) and are preferably evenly disposed on the entire surface. For example, the surface sensors 123a are disposed at the positions of the vertices of, for example, a regular octahedron or a regular dodecahedron that inscribes in the controller main body 11 constituting a sphere.

In the following description, the position of each of the plurality of surface sensors 123a in the sensor coordinate system is assumed to be known.

Using the surface sensors 123a makes it possible for the control section 121 to detect the following operations performed by the user: (1) an operation of touching the controller main body 11, (2) an operation of pressing a part of the controller main body 11 by a finger or fingers, and (3) an operation of putting his/her hand closer to the controller main body 11. Further, the position touched by the user, the position pressed by the user, or the position where the user has put his/her hand close to the controller main body 11 in the sensor coordinate system can be detected from the position of the surface sensor 123a that has detected such a position.

Further, in a case where the controller main body 11 is configured with an elastically deformable material, using the surface sensors 123a that detect the direction and magnitude of force applied by the user on the controller main body 11 makes it possible for the control section 121 to detect the following operations in addition to the operations described in (1) through (3) above: (4) an operation of rubbing the surface of the controller main body 11 by a palm of the hand or a finger or fingers, (5) an operation of twisting the controller main body 11, (6) an operation of pinching (an operation of pinching and pulling) a part of the controller main body 11, and (7) an operation of squeezing and crushing the entire controller main body 11.

For example, the operations described in (1) through (3) above such as (1) the operation of touching and (3) the operation of putting a hand closer can be detected by use of an electrostatic sensor as the surface sensor 123a.

Further, (4) the operation of rubbing the surface, (5) the operation of twisting, (6) the operation of pinching (the operation of pinching and pulling) a part, specifically, an operation of pinching and pulling a part of the controller main body 11 in a state in which the controller main body 11 is held in one hand, and further, (7) the operation of squeezing and crushing, for example, can be detected by use of a pressure sensor, a strain sensor, an acceleration sensor, and the like as the surface sensor 123a. The position and the direction in the sensor coordinate system such as the rubbed position, the twisted direction, the pinched position, and the squeezed direction are detected by the positions and the like of the surface sensors 123a that have detected such operations.

The communication section 124 is an interface of a wired communication system such as a USB (universal serial bus) or a wireless communication system such as Bluetooth (registered trademark) and is connected to the information processing device 30 in a manner allowing communication therewith in a wired or wireless manner. The communication section 124 transmits information to the information processing device 30 in accordance with the instruction input from the control section 121. Further, the communication section 124 outputs, to the control section 121, the information received from the information processing device 30.

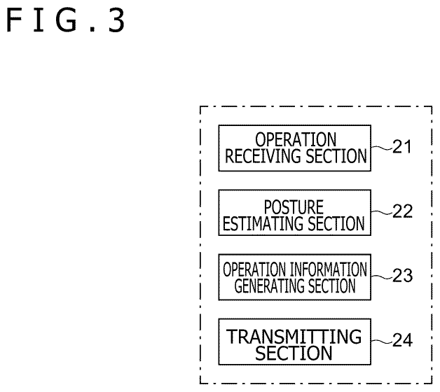

The operation of the control section 121 of the circuit unit 12 will next be described. Executing the programs stored in the storage section 122, the control section 121 implements a configuration functionally including an operation receiving section 21, a posture estimating section 22, an operation information generating section 23, and a transmitting section 24, as illustrated in FIG. 3.

The operation receiving section 21 receives the operation performed by the user on the controller main body 11. Specifically, the operation receiving section 21 detects the operations performed by the user as exemplified in (1) through (7) above, for example, in reference to the result of detection output by each surface sensor 123a, and outputs, as information concerning the direction in the sensor coordinate system, information concerning the direction in which the controller main body 11 is pressed, for example.

The posture estimating section 22 estimates the posture of the controller main body 11 at a predetermined timing. This timing may, for example, be a timing of detecting a predetermined initialization operation by the operation receiving section 21, or each timing of detecting an operation by the operation receiving section 21. In one example of the present embodiment, the initialization operation may, for example, be an operation of continuously pressing a part of the controller main body 11 with a force equal to or greater than a predetermined threshold value for a predetermined length of time or longer, or such an operation of holding the controller and swinging the controller within an angular range greater than a predetermined angular range (swinging back and forth within the angular range) for a predetermined number of times (for example, twice), for example.

As one example, when the initialization operation is detected, the posture estimating section 22 uses the output of the posture sensor 123b output by the sensor section 123 and detects the gravity direction in the sensor coordinate system. Here, the method of detecting the gravity direction by the 9-axis IMU sensor constituting the posture sensor 123b is widely known, and hence, the detailed description thereof will be omitted.

Further, after detecting the gravity direction, the posture estimating section 22 uses the output of the sensor section 123 and estimates the posture of the controller main body 11. Specifically, the posture estimating section 22 instructs the information processing device 30 to output a guide screen giving a guidance on a predetermined operation to the user, after the initialization operation has been performed and the gravity direction has been detected. Here, the predetermined operation for which a guidance is to be given is, for example, an operation of applying an acceleration in a predetermined direction to the controller device 10; as one example, the posture estimating section 22 instructs the information processing device 30 to make such a display that reads “hold the controller device 10 with your right hand, and swing it from side to side.” At this time, the user is assumed to perform the action of holding the controller device 10 with his/her right hand and swinging the controller device 10 from side to side as viewed from the user, in accordance with the instruction.

The posture estimating section 22 uses the result of detection output by the sensor section 123 according to the operation for which a guidance has been given here and which has been performed by the user and estimates the posture of the controller main body 11. As one example, the posture estimating section 22 estimates the left and right direction of the user by using the output of the surface sensor 123a.

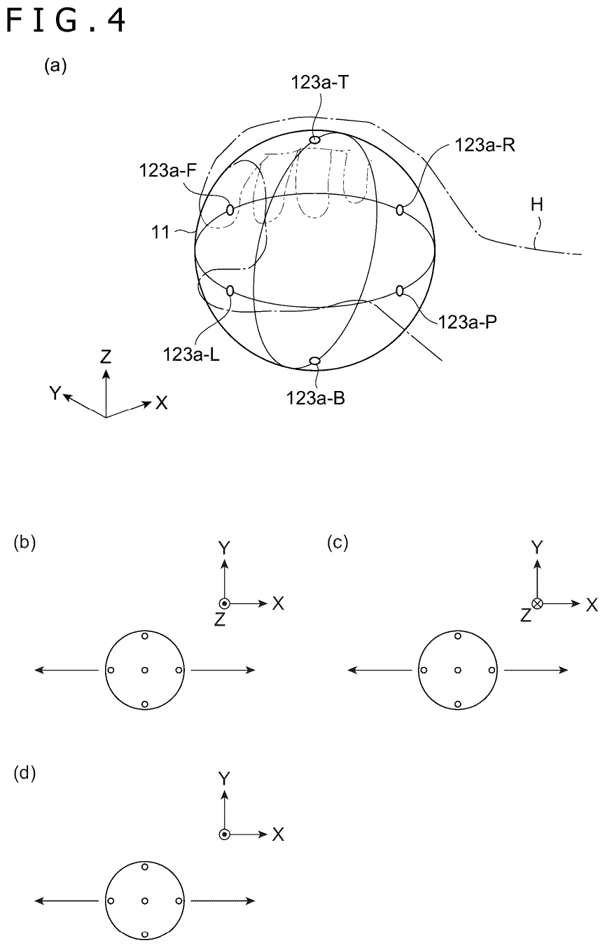

This estimation is performed, for example, in the following manner. Specifically, when the user holds the controller main body 11, as illustrated in FIG. 4(a), the surface sensors 123a that are located at the positions where the fingers are placed and the positions where the palm of the hand is close thereto or in contact therewith detect the fingers and hand of the user. In FIG. 4, the left and right direction as viewed from the user is defined as an X-axis (the right as viewed from the user is defined as the positive direction), a normal direction of a coronal plane of the user's body is defined as a Y-axis (the direction farther away from the user is defined as the positive direction), and the gravity direction is defined as a Z-axis (the upper side is defined as the positive direction). In the following description, this XYZ coordinate system is called a user coordinate system.

In FIG. 4(a), for the sake of description, the surface sensors 123a are provided at vertexes of a regular octahedron that inscribes in the controller main body 11 constituting a sphere. Yet, in reality, more surface sensors 123a may be provided.

Here, while there are various ways for the user to hold the controller main body 11 that constitutes a sphere, holding the controller main body 11 with the right hand without unnaturally bending the wrist would be performed in any of the following manner: (a) holding the controller main body 11 from an upper side (the palm of the hand is placed above the controller main body 11), (b) holding the controller main body 11 from a lower side (the palm of the hand is below the controller main body 11), or (c) holding the controller main body 11 from the right side (the palm of the hand is on the right side of the controller main body 11).

For example, when the user holds the controller main body 11 from the upper side, as illustrated in FIGS. 4(a) and 4(b), at least a surface sensor 123a-B that is located in a gravity direction (the Z-axis negative direction) from the center of the controller main body 11 and a surface sensor 123a-P that is located on the body side of the user do not detect the fingers and a hand H of the user.

Meanwhile, at this time, a surface sensor 123a-L on the left side of the user and a surface sensor 123a-F on the opposite side of the body of the user detect contact of the user's fingers with the controller main body 11, and a surface sensor 123a-T located on the upper side of the controller main body 11 detects contact of the palm of the hand with the controller main body 11.

Here, when the user moves the controller main body 11 in the left and right direction, the posture estimating section 22, assuming that that surface sensors 123a-L and 123a-R in that left and right direction are provided in the left and right direction of the user (that is, assuming that the left and right direction is a direction parallel to the X-axis), refers to the result of detection by the surface sensor 123a-P, which is on the body side of the user, and a surface sensor 123a-F, which is on the opposite side of the body, both being the surface sensors 123a that are different from the surface sensors 123a-L and 123a-R and that are provided in a direction perpendicular to the gravity direction (in other words, within a horizontal plane).

Further, on the assumption that the user's body is positioned on the side where no contact is detected (in the example here, the surface sensor 123a-P side), a Y-axis direction is defined. Further, the Y-axis direction defined here and a Z-axis direction defined by the gravity direction are used to determine an X-axis direction (in the example here, the right side of the user is defined as the positive direction).

Further, also when the user (b) holds the controller main body 11 from the lower side (FIG. 4(c)) or (c) holds the controller main body 11 from the right side (FIG. 4(d)), similar processes are performed for the posture estimating section 22 to define each of the X-axis, Y-axis, and Z-axis directions.

Note that the example described here is merely illustrative, and any other different method may be adopted if the orientation of the user's body can be detected, i.e., if the X-axis, Y-axis, and Z-axis directions can be determined.

The posture estimating section 22 obtains a conversion equation (hereinafter referred to as a user coordinate system conversion equation; this conversion equation is represented as a quaternion) that mutually converts the sensor coordinate system including axes of acceleration directions detected by the posture sensor 123b and the user coordinate system (XYZ coordinate system) in the manner described above. The user coordinate system conversion equation corresponds to posture information representing the posture of the controller device 10 (each direction of the controller main body as viewed from the user).

Further, the posture estimating section 22 obtains a conversion equation (which is called an orientation conversion equation; this conversion equation is also represented by a quaternion) that mutually converts the orientation (the north pole or south pole direction) detected by the posture sensor 123b and the user coordinate system.

The operation information generating section 23 acquires at least the user coordinate system conversion equation obtained by the posture estimating section 22 and, every time the user performs an operation, converts information representing the user's operation (each of which is represented by the sensor coordinate system) which is detected by the operation receiving section 21, such as the position where the user's hand or fingers have come into contact with the controller main body 11 or the direction of force applied to the controller main body 11 by the user, into information representing the user's operation in the user coordinate system with use of the abovementioned conversion equation.

This allows such information representing the operation performed by the user as being pressed from the right side or being pressed from the left side as viewed from the user to be obtained.

The transmitting section 24 transmits, to the information processing device 30, information representing the user's operation in the user coordinate system which is generated by the operation information generating section 23.

The information processing device 30 receives the information representing the user's operation in the user coordinate system from the controller device 10 and supplies such information for use in processing of controlling a game application, for example.

### Example of Operation

The controller device 10 according to the present embodiment basically has the configuration described above and operates in the following manner. The user who uses the controller device 10 initially holds the controller device 10 and performs a predetermined initialization operation.

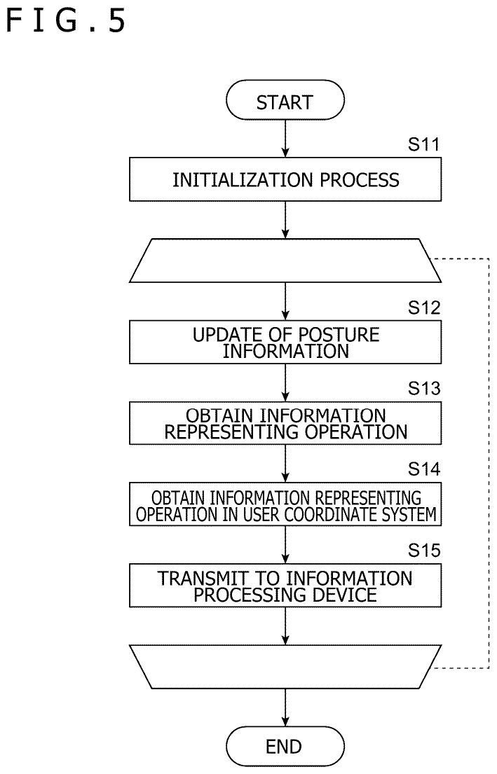

Then, the controller device 10 performs the initialization process as illustrated in FIG. 5 (S11), and first uses the output of the posture sensor 123b to detect the gravity direction in the sensor coordinate system.

This initialization process is assumed to be, for example an operation of moving the controller device 10 back and forth in the front and rear direction after moving the controller device 10 from side to side in the left and right direction of the user (swinging the controller device 10 in two directions, the left and right direction and front and rear direction, in order) or an operation of holding the controller device 10 in a predetermined posture by maintaining the state of keeping still the controller device 10 with a predetermined surface thereof facing the side of the user's belly (for example, pressing the predetermined surface toward the user's belly side). Specifically, the controller device 10 communicates with the information processing device 30 and instructs the information processing device 30 to perform such a display that reads “hold the controller device 10 with your right hand, and swing the controller device 10 from side to side.” In accordance with this instruction, the information processing device 30 performs such a display that reads “hold the controller device 10 with your right hand, and swing the controller device 10 from side to side.”

When the user, in accordance with this instruction, performs the operation of holding the controller device 10 with his/her right hand and swinging the controller device 10 from side to side as viewed from his/her side, the controller device 10 detects the X-axis direction in reference to the result of detection of contact with the user's hand and fingers by the surface sensor 123a and the result of detection of the movement direction by the posture sensor 123b. Here, the direction in which the controller device 10 has moved first is defined as the X-axis negative direction.

Thereafter, the controller device 10 communicates with the information processing device 30 again and instructs the information processing device 30 to perform such a display that reads “first, press the controller device 10 against your belly while holding the controller device 10 with your right hand, and then swing the controller device 10 back and forth.” The information processing device 30, in accordance with this instruction, performs such a display that reads “first, press the controller device 10 against your belly while holding the controller device 10 with your right hand, and then swing the controller device 10 back and forth.”

When the user, following this instruction, performs the operation of swinging the controller device 10 back and forth as viewed from his/her side after pressing the controller device 10 against his/her belly while maintaining the state of holding the controller device 10 with his/her right hand, the controller device 10 detects the orientation of the body of the user (the Y-axis negative direction), in reference to the result of detection of contact with the user's hand and fingers by the surface sensors 123a and the result of detection of the movement direction by the posture sensor 123b. In this example, the direction in which the first movement is made is the direction separating away from the user's body (the Y-axis positive direction).

Specifically, as already described, the controller device 10 detects the X-axis and Y-axis positive directions from the movement direction detected by the posture sensor 123b.

Further, by defining the direction perpendicular to both the detected X-axis and Y-axis, as the Z-axis direction, the controller device 10 assumes, for example, that a left-handed system is used and determines the Z-axis positive direction. This allows the controller device 10 to obtain the vectors in the sensor coordinate system that represent the positive direction of each of the X-axis, Y-axis, and Z-axis in the user coordinate system. Then, the controller device 10 obtains the user coordinate system conversion equation that mutually converts the sensor coordinate system and the user coordinate system (XYZ coordinate system) and ends the initialization process. In this example, the gravity direction is, when the user operates the controller device 10 in a state of standing, the Z-axis negative direction in the user coordinate system. Further, when the user operates the controller device 10 in a state of lying down, the gravity direction is the Y-axis negative direction in the user coordinate system.

Subsequently, the controller device 10 repetitively performs the following processes in steps S12 to S15 until the user ends the operation (for example, until a state in which the user's hand or fingers are not detected has continued for a predetermined length of time).

Here, the controller device 10 updates the user coordinate system conversion equation according to the change in the posture of the controller device 10 after the initialization processing (S12: update of posture information). As this update method, for example, use of widely known methods (for example, the method disclosed in https://qiita.com/Tanba28/items/5092c3e5e2c631b804f3) such as the method of using an output of a gyro sensor and a method of using an orientation conversion equation in addition to an output of the gyro sensor is sufficient.

The controller device 10 obtains information representing the user's operation such as the position where the user's hand or fingers are in contact with the controller main body 11 and which is detected by the surface sensor 123a and the direction of the force applied by the user on the controller main body 11 (each of which is represented by the sensor coordinate system) (S13) and converts the obtained information into information representing the user's operation in the user coordinate system with use of the user coordinate system conversion equation updated in step S12 (S14).

Thereafter, the controller device 10 outputs, to the information processing device 30, information that is obtained in step S14 and that represents the user's operation in the user coordinate system (S15).

The information processing device 30 receives, from the controller device 10, information representing the user's operation in the user coordinate system, and provides the information for such processing of controlling a game application, for example.

### Reset by Initialization Operation

The controller device 10 according to the present embodiment may transit to the abovementioned initialization process (step S11) and continue the process whenever a predetermined initialization operation has been performed. This allows the user to reset the operation of the controller device 10 at any time.

Other Examples of the Operation Method of the Controller Device

An example in which the user performs the operation of holding the controller device 10 with one hand and pressing the controller device 10 by any finger, deforming the controller device 10 by gripping, or pinching a part of the controller device 10 has been described so far, but the method of performing an operation on the controller device 10 is not limited to these examples.

The controller device 10 according to the present embodiment may be held by three fingers including the thumb, the forefinger, and the middle finger instead of being held by five fingers as described above. In any case, when the user naturally holds the controller device 10 without twisting his/her wrist, as illustrated in FIG. 4, if the user is holding the controller device 10 with his/her right hand, the palm of the hand is assumed to be oriented upward (FIG. 4(b)), downward (FIG. 4(c)), or rightward (FIG. 4(d)), so that the controller device 10 can detect the direction of the palm of the hand by the surface sensor 123a in the specific direction detecting the contact of the user's hand and fingers, and can also estimate the position of the thumb or the positions of other fingers such as the forefinger and the middle finger.

Hence, when the controller main body 11 is pressed at any of the positions of the fingers that have been estimated, the controller device 10 may transmit information indicating the specific finger that has pressed the controller main body 11 to the information processing device 30.

In this example, the information processing device 30 can perform processes on such assumptions that different operations have been received between the case where the position of the thumb has been pressed and the case where the position of the forefinger has been pressed, for example, by setting of a game application and the like. That is, in this example, in no matter what direction the user holds the controller device 10, the positions of the user's fingers on the controller main body 11 function in a manner similar to that of the buttons of a controller in the related art. Further, a combination of such a function and pressing information can be used for making such a determination as to whether the designated finger is pressing with optimum pressure in software for training a massaging method, whether the bread dough is kneaded with optimum pressure in a game for cooking, or whether a rice ball is made with the right shape of the hand.

Further, the controller main body 11 of the controller device 10 according to the present embodiment preferably has a symmetric shape around at least one axis, so that the operation of rotating the controller main body 11 about this axis may be performed.

In a case where the user rotates the controller device 10 by rolling the controller device 10 on the palm of the hand, for example, the controller device 10 sequentially detects the positions where the user's hand comes into contact or performs the process of updating the user coordinate system conversion equation which has already been described as using the output of the gyro sensor and thereby obtains information concerning the rotation direction, the rotation amount, and the rotation speed. The controller device 10 transmits these pieces of information to the information processing device 30, which uses the pieces of information concerning the rotation direction, the rotation amount, and the rotation speed of the controller device 10 for such processing of controlling a game application or the like. For example, this can be applied to such a game in which an operation of moving a ball while rolling it along a predetermined course or polishing a surface of an object is performed.

Further, in a case where the controller device 10 can be separated from the hand such as a case where the user is not wearing an HMD or is wearing a transmittance-type HMD, the user can roll the controller device 10 on a table or on the floor. In this case, the controller device 10 obtains pieces of information concerning the rotation direction, the rotation amount, and the rotation speed by the process of updating the user coordinate system conversion equation which has already been described as using the output of the gyro sensor, for example.

Further, this controller device 10 can be used by being thrown. In this example, the controller device 10 determines that the controller device 10 is in the air from the point in time when the user's hand or fingers, which had been detected as being in contact with the controller device 10, are no longer detected as being in contact with the controller device 10 until a shock equal to or greater than a predetermined acceleration is applied to the controller device 10 (or the controller device 10 lands on the ground or collides with something) (or, until the controller device 10 stands still, that is, the user coordinate system conversion equation is not updated for a predetermined length of time or longer by the process of updating the user coordinate system conversion equation). Then, while determining itself to be in the air, the controller device 10 detects the movement trajectory and rotation of the controller device 10 itself from the output of the gyro sensor or by the process of updating the user coordinate system conversion equation, for example. Subsequently, the controller device 10 transmits these pieces of information concerning the movement trajectory and rotation that have been detected to the information processing device 30, which uses the pieces of information concerning the movement trajectory and rotation of the controller device 10 while the controller device 10 is in the air for such processing of controlling a game application, for example. This example can, for example, be applied to such a game including an action of throwing a ball such as a baseball game or a ball toss game. Further, for example, the information processing device 30 may use information concerning the positions of the user's fingers in contact with the surface of the controller main body 11 that is obtained at a point in time immediately prior to the point in time when the controller device 10 is determined to be in the air or use the information concerning the positions of the fingers or the pieces of information concerning the start trajectory and rotation and perform processing of a game or the like on an assumption that a ball has been thrown by such pitches as a curveball or a fork-ball.

Moreover, while the description so far has been made by taking, as an example, a case in which the user uses the controller device 10 by holding the controller device 10 in his/her hand, the controller device 10 according to the present embodiment may be used by being placed on a table or the like. For example, possible are such an example in which the controller device 10 placed on a table is operated by being smashed down, an example in which an object is operated by force being applied to the controller device 10 in the shear direction by the forefinger, or an example of performing an operation of moving a cursor on a graphical user interface or selecting and choosing the radio button by using the controller device 10 as a replacement of a pointing device (what is generally called a mouse device) of a computer device.

### Case where there are a Plurality of Controller Devices

Further, the number of controller devices 10 connected to the information processing device 30 may be two for each user. In this case, in performing communication with the information processing device 30, each controller device 10 includes identification information uniquely assigned to itself in the information which each controller device 10 transmits to the information processing device 30.

Further, in this case, the information processing device 30 may sequentially give a guidance to the user on the controller devices 10 to be held by each of the left and right hands by giving such an instruction that reads “first, pick up the controller device to be held by your right hand,” and then identify the identification information of the controller device 10 held by the user with his/her right hand and the identification information of the controller device 10 held by the user with his/her left hand by the order in which the controller devices 10 are picked up.

In another example, the information processing device 30 may give a guidance to the user to perform some kind of operation on the controller devices 10 held by the user on each of the left and right hands by giving to the user such an instruction that reads “hit the controller device you are holding with your right hand against the table” and detect that a corresponding operation has been performed, to identify the identification information of the controller device 10 held by the user with the right hand and the identification information of the controller device 10 held by the user with the left hand.

In an example in which the user uses a plurality of controller devices 10 as described above, the user performs the initialization process at any timing on the controller devices 10 (for example, at a timing when the user switches the controller devices 10 held by each of the left and right hands). Hence, when a predetermined operation is performed, the controller devices 10 may perform an initialization process that receives the initialization operation.

Further, the number of controller devices 10 connected to the information processing device 30 may be three or more instead of being two for each user. In this example, after performing the initialization operation on each of the controller devices 10 in advance, the user places the controller devices 10 within his/her reach and performs an operation by picking up the controller devices 10 as needed. For example, in such a game as a ball toss game, the user would perform an operation of sequentially tossing the plurality of controller devices 10.

### REFERENCE SIGNS LIST

10: Controller device
11: Controller main body
12: Circuit unit
21: Operation receiving section
22: Posture estimating section
23: Operation information generating section
24: Transmitting section
30: Information processing device
31: Control unit
32: Storage unit
33: Communication unit
34: Display unit
110: Housing
121: Control section
122: Storage section
123: Sensor section
124: Communication section

1. A controller device comprising:
a controller main body; and
a control unit, wherein
the control unit includes
operation receiving means for receiving an operation performed by a user on the controller main body,
estimating means for estimating a posture of the controller main body, and
operation information generating means for generating information representing contents of the received operation and outputting the information, by using a result of estimation by the estimating means.

2. The controller device according to claim 1, further comprising:
a sensor unit,
the sensor unit
including at least one of
an acceleration sensor,
a geomagnetic sensor, and
a gyro sensor, and
outputting a result of detection by the sensor included, wherein
the estimating means estimates the posture of the controller main body by using an output of the sensor unit as of a point in time when the operation performed by the user is received.

3. The controller device according to claim 1, further comprising:
a sensor unit that includes at least an acceleration sensor and that outputs a result of detection by the sensor included; and
guiding means that gives, to the user, a guidance on an operation for applying an acceleration in a predetermined direction to the controller device, wherein
the estimating means estimates the posture of the controller main body by using the result of detection output by the sensor unit according to the operation for which a guidance has been given by the guiding means.

4. The controller device according to claim 1, wherein the controller main body is formed by an elastic deformable material.

5. The controller device according to claim 1, wherein the controller main body has a rotationally symmetric shape around at least one axis.

6. The controller device according to claim 5, wherein the controller main body constitutes a sphere.

7. A method for controlling a controller device including a controller main body and a control unit, the method comprising:
by the control unit,
receiving an operation performed by a user on the controller main body;
estimating a posture of the controller main body; and
generating information representing contents of the received operation and outputting the information, by using a result of estimation of the posture.

8. A non-transitory, computer readable storage medium containing a program for causing a control unit of a controller device including a controller main body and the control unit to carry out a method, comprising:
receiving an operation performed by a user on the controller main body;
estimating a posture of the controller main body; and
generating information representing contents of the received operation and outputting the information, by using a result of the estimating.
